(19) United States
(12) Patent Application Publication
(10) Pub. No.: US 2026/0109098 A1
(43) Pub. Date: Apr. 23, 2026

(54) EXTRUSION OF HIGH MOISTURE PHA

(71) Applicant: Danimer IPCo, LLC, Bainbridge, GA (US)

(72) Inventors: Brock Merchant, Whigham, GA (US); Ryan Mullins, Tallahassee, FL (US)

(73) Assignee: Danimer IPCo, LLC, Bainbridge, GA (US)

(21) Appl. No.: 19/117,201

(22) PCT Filed: Oct. 2, 2023
(86) PCT No.: PCT/US2023/034273

§ 371 Date: Mar. 31, 2025

Related U.S. Application Data
(60) Provisional application No. 63/412,670, filed on Oct. 3, 2022.

(51) Int. Cl. B29C 48/00; B29K 67/00; B29K 105/00; B29K 105/16; B29K 509/00

(52) U.S. Cl. CPC B29C 48/022; B29K 2067/04; B29K 2105/0005; B29K 2105/16; B29K 2509/00

(57) ABSTRACT

The present disclosure provides a method for extruding high moisture polyhydroxyalkanoates. The method includes a step of mixing at least one polyhydroxyalkanoate in powder form and having an initial moisture content of at least 0.10 weight percent, with at least one resin additive at a temperature from about 120 to about 190° C. to form an extrusion mixture. This mixture is then extruded through an extrusion die to form a resin extrudate comprising the at least one polyhydroxyalkanoate and the at least one resin additive.

### FIELD

This disclosure relates to biodegradable polymeric compositions. More particularly, this disclosure relates to extrusions of biodegradable polymers, such as polyhydroxyalkanoates, which are extruded under elevated moisture conditions.

### BACKGROUND

Many polymeric materials, including biodegradable polymers such as polyhydroxyalkanoate, are conventionally extruded, either to form a final product or an intermediate pellet, which will subsequently be remelted and formed into a final product.

Conventionally, it is necessary to thoroughly dry the polymer prior to heating and extruding the polymer. This process is particularly true with polyhydroxyalkanoate. Typically, significant degradation of the polyhydroxyalkanoate due to hydrolysis (with an accompanying reduction in molecular weight) is observed if the polyhydroxyalkanoate is not dried to a very low moisture level prior to heating and extruding.

Such drying of the polyhydroxyalkanoate, however, is an energy and time-intensive process. Thus, it would be desirable to melt extrude polyhydroxyalkanoates with a higher initial moisture content and thus with a reduced need for an extended drying process prior to melt extrusion. At the same time, the polyhydroxyalkanoate should not exhibit significant hydrolysis degradation of the polymer or loss of molecular weight.

### SUMMARY OF THE INVENTION

The above and other needs are met by a method for extruding high moisture polyhydroxyalkanoates, according to the present disclosure. In one embodiment, the method of the present disclosure includes a step of mixing at least one polyhydroxyalkanoate in powder form with at least one resin additive at a temperature from about 120 to about 190° C. to form an extrusion mixture. This mixture is then extruded through an extrusion die to form a resin extrudate comprising the at least one polyhydroxyalkanoate and the at least one resin additive.

According to the present disclosure, the at least one polyhydroxyalkanoate in powder form has an initial (i.e., prior to mixing) moisture content of at least 0.10 weight percent, as determined in accordance with ASTM D7191-05, when mixed with the at least one resin additive. In certain embodiments, the polyhydroxyalkanoate powder may have an even higher moisture content. In some instances, the least one polyhydroxyalkanoate in powder form may have an initial moisture content of at least 1 weight percent, at least 5 weight percent, at least 10 weight percent, at least 15 weight percent, or even greater, as determined in accordance with ASTM D7191-05, when mixed with the at least one resin additive.

According to certain embodiments, the mixing step and the extruding steps are preferably carried out in different devices or in different chambers of the same device. In some instances, the mixing step is preferably carried out in a low-shear continuous mixer. In some embodiments, it is also preferred that the extruding step is carried out in a screw extruder.

In some instances, the at least one polyhydroxyalkanoate preferably has an initial weight average molecular weight before the mixing step and a final weight average molecular weight after the extruding step, which is at least 40 percent of the initial weight average molecular weight, wherein all weight average molecular weights are determined in accordance with ASTM D5296-05. More preferably, the final weight average molecular weight of the at least one polyhydroxyalkanoate is at least 70 percent of the initial weight average molecular weight, still more preferably at least 80 percent of the initial weight average molecular weight, and even more preferably at least 85 percent of the initial weight average molecular weight.

A variety of different forms of polyhydroxyalkanoate may be used in the method of the present disclosure. In certain embodiments, the at least one polyhydroxyalkanoate is made up of poly-3-hydroxybutyrate-co-3-hydroxyhexanoate (“P(3HB-co-3HHx)”). In some embodiments, this P(3HB-co-3HHx) is preferably made up of from about 75 to about 99 mole percent hydroxybutyrate and from about 1 to about 25 mole percent hydroxyhexanoate.

In other embodiments, the at least one polyhydroxyalkanoate is preferably made up of from about 1 to about 25 weight percent of at least one polyhydroxyalkanoate comprising from about 25 to about 50 mole percent of hydroxyvalerate, hydroxyhexanoate, hydroxyoctanoate, and/or hydroxydecanoate. In some embodiments, the at least one polyhydroxyalkanoate preferably includes a terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydroxyalkanoate having from 5 to 12 carbon atoms.

In some instances, the at least one poly(hydroxyalkanoate) preferably has an initial weight average molecular weight from about 50,000 Daltons to about 2.5 million Daltons, as determined by ASTM D5296-05.

According to certain embodiments, the at least one resin additive preferably includes at least one rheology modifier selected from the group consisting of vinyl acetate homopolymers or copolymers, peroxides, epoxides, isocyanates, carbodiimides, and mixtures thereof.

In some embodiments, the at least one resin additive preferably includes at least one nucleating agent from the group consisting of pentaerythritol, boron nitride, poly(hydroxybutyrate), inositol, clays, dipentaerythritol, sorbitol, and mixtures thereof.

In some instances, the at least one resin additive preferably includes at least one filler selected from the group consisting of aragonite, clays, calcium carbonate, cellulose, nano-cellulose, talc, kaolinite, montmorillonite, bentonite, silica, chitin, starches, diatomaceous earth, titanium dioxide, nano clay, mica, and mixtures thereof.

Moreover, in certain embodiments, the mixing step may also include mixing the at least one polyhydroxyalkanoate in powder form with at least one biopolymer selected from the group consisting of biodegradable polymer selected from the group consisting of polybutylene succinate, polycaprolactone, polybutylene succinate-co-butylene adipate, polybutylene adipate-co-terephthalate, polylactic acid, cellulose acetate, and mixtures thereof.

### DETAILED DESCRIPTION

The present disclosure provides a method for extruding high-moisture polyhydroxyalkanoates. Conventionally, polyhydroxyalkanoates must be dried to a very low moisture content prior to extrusion to prevent hydrolysis degradation of the polyhydroxyalkanoates.

According to the method of the present disclosure, however, the present inventors have found that polyhydroxyalkanoates having a substantially higher moisture content may be extruded without substantial polymer degradation due to hydrolysis.

In general, the method of the present disclosure includes a first step of mixing at least one polyhydroxyalkanoate in powder form with at least one resin additive at a temperature from about 120 to about 190° C. to form an extrusion mixture. This mixture is then extruded through an extrusion die to form a resin extrudate comprising the at least one polyhydroxyalkanoate and the at least one resin additive.

As noted above, the at least one polyhydroxyalkanoate in powder form has an unusually high initial moisture content prior to the mixing steps. Typically, the least one polyhydroxyalkanoate has an initial (prior to mixing) moisture content of at least 0.1 weight percent, as determined in accordance with ASTM D7191-05, when mixed with the at least one resin additive. In some instances, the polyhydroxyalkanoate powder may have an even higher moisture content. For example, the least one polyhydroxyalkanoate in powder form may have an initial moisture content of at least 1 weight percent, at least 5 weight percent, at least 10 weight percent, or even at least 15 weight percent, as determined in accordance with ASTM D7191-05, when mixed with the at least one resin additive.

The method of the present disclosure may be carried out using a wide variety of forms of polyhydroxyalkanoate, including homopolymers, copolymers, terpolymers, and blends of the foregoing.

Thus, in some embodiments, the polyhydroxyalkanoate may include a homopolymer such as poly(hydroxybutyrate).

In other instances, the polyhydroxyalkanoate may include a copolymer or a terpolymer. For example, in some embodiments, the at least one polyhydroxyalkanoate comprises poly-3-hydroxybutyrate-co-3-hydroxyhexanoate (“P(3HB-co-3HHx)”). In some embodiments, this P(3HB-co-3HHx) is preferably made up of from about 75 to about 99 mole percent hydroxybutyrate and from about 1 to about 25 mole percent hydroxyhexanoate.

In other embodiments, the at least one polyhydroxyalkanoate preferably comprises from about 1 to about 25 weight percent of at least one polyhydroxyalkanoate comprising from about 25 to about 50 mole percent of hydroxyvalerate, hydroxyhexanoate, hydroxyoctanoate, and/or hydroxydecanoate. In still other embodiments, the at least one polyhydroxyalkanoate preferably comprises a terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydroxyalkanoate having from 5 to 12 carbon atoms.

At least one resin additive is mixed with the polyhydroxyalkanoate to form the extrusion mixture. Examples of resin additives that may be mixed with the polyhydroxyalkanoates include rheology modifiers, nucleating agents, organic fillers, inorganic fillers, polyesters, and impact modifiers.

For example, in certain embodiments, the at least one resin additive preferably comprises at least one rheology modifier selected from the group consisting of vinyl acetate homopolymers or copolymers, peroxides, epoxides, isocyanates, carbodiimides, and mixtures thereof.

In some embodiments, the at least one resin additive preferably comprises at least one nucleating agent from the group consisting of pentaerythritol, boron nitride, poly(hydroxybutyrate), inositol, clays, dipentaerythritol, sorbitol, and mixtures thereof.

In some instances, the at least one resin additive preferably comprises at least one filler selected from the group consisting of aragonite, clays, calcium carbonate, cellulose, nano-cellulose, talc, kaolinite, montmorillonite, bentonite, silica, chitin, starches, diatomaceous earth, titanium dioxide, nano clay, mica, and mixtures thereof.

Moreover, in certain embodiments, the mixing step may also include mixing the at least one polyhydroxyalkanoate in powder form with at least one biopolymer selected from the group consisting of biodegradable polymer selected from the group consisting of polybutylene succinate, polycaprolactone, polybutylene succinate-co-butylene adipate, polybutylene adipate-co-terephthalate, polylactic acid, cellulose acetate, and mixtures thereof. In such embodiments, the additional biopolymer may be added to the mixture in a weight ratio of from about 1 to about 75 parts by weight of the biopolymer per 100 parts by weight of the at least one polyhydroxyalkanoate.

According to the present disclosure, the mixing step and the extruding step are carried out separately. In some instances, the mixing step and the extruding step are carried out in separate devices. In other instances, the mixing step and the extruding step are carried out in separate chambers of a single device.

For example, according to certain embodiments of the present disclosure, the mixing step is preferably carried out in a continuous mixer, typically operating under relatively low-shear mixing conditions. An example of a suitable mixing system is the Farrel Continuous Mixer, available from Farrel Pomini.

Typically, a continuous mixer such as the aforementioned Farrel mixer has a mixing chamber with two counter-rotating, non-intermeshing rotors (i.e., screws) for mixing of materials. As noted, the flights of the two rotors do not intermesh, and the rotors are sized to provide a relatively large free volume within the mixing chamber. This large free volume within the mixing chamber is due to the lack of intermeshing of the rotor flights and also to the relatively large gap between the screw flights and the wall of the extrusion chamber. In conventional screw extruders, this gap is quite small, and extreme shear is exerted upon the material as it moves through this tight gap. With the larger gap in the continuous mixer, the amount of shear exerted on the material as it moves through this gap is reduced. This lower shear is believed to reduce the amount of degradation in the material.

Moreover, the continuous mixer also allows for internal water cooling to be applied to the extruder screws. Preferably, the extruder screws are cooled to maintain the material in the mixer at a temperature from about 120° C. to about 190° C.

After initial mixing under the aforementioned conditions, the extrusion mixer may then be transferred to a conventional screw extruder for the final extruding step.

As discussed above, it has surprisingly been observed that polyhydroxyalkanoates that have been mixed and extruded in accordance with the present disclosure do not exhibit a large degree of polymer degradation due to hydrolysis despite the elevated moisture content of the starring polyhydroxyalkanoates.

For instance, in some instances, the at least one poly(hydroxyalkanoate) preferably has an initial (i.e., before mixing with the resin additive) weight average molecular weight from about 50,000 Daltons to about 2.5 million Daltons, as determined by ASTM D5296-05. More preferably, the at least one poly(hydroxyalkanoate) preferably has an initial weight average molecular weight from about 300,000 Daltons to about 2.5 million Daltons, as determined by ASTM D5296-05

Advantageously, according to the present disclosure, the at least one polyhydroxyalkanoate preferably has an initial weight average molecular weight before the mixing step and a final weight average molecular weight after the extruding step, which is at least 40 percent of the initial weight average molecular weight, wherein all weight average molecular weights are determined in accordance with ASTM D5296-05. More preferably, the final weight average molecular weight of the at least one polyhydroxyalkanoate is at least 70 percent of the initial weight average molecular weight, still more preferably at least 80 percent of the initial weight average molecular weight, and even more preferably at least 85 percent of the initial weight average molecular weight.

### EXAMPLES

The following non-limiting examples illustrate various additional aspects of the invention. Unless otherwise indicated, temperatures are in degrees Celsius, and percentages are by weight based on the dry weight of the formulation.

### Examples 1-24

For these examples, according to the present disclosure, a series of samples of polyhydroxyalkanoate (PHA) were prepared, each having a different initial moisture content ranging from 0.15 weight percent to about 15 weight percent. For each sample, the PHA was a poly-3-hydroxybutyrate-co-3-hydroxyhexanoate copolymer, comprising about 6 mole percent 3-hydroxyhexanoate monomer repeat units. The initial weight average molecular weight of the PHA copolymer was about 1,032,000, as determined by ASTM D5296.

The PHA was initially provided as a substantially dry powder. For each sample, the powder was mixed in a bucket with a known amount of water and stirred with a paint stirrer to provide a PHA sample having a known initial moisture content.

Each sample of the PHA was then mixed using a Farrel C-PEX lab scale continuous mixer. The PHA material was fed through the continuous mixer at a rate of about 12 kilograms/hour. For convenience in these examples, the PHA was mixed in the continuous mixer by itself, without any additives. The temperature profile within the continuous mixer was set to 140° C. Also, the mixing screws within the continuous mixer were internally cooled using chill water.

After feeding through the continuous mixer, the material is dropped into a conveying screw, which pumps the material to an extrusion die steadily to allow for extrusion and pelletizing. The conveying screw is a single screw extruder set at a temperature range of 120-140° C.

After extrusion and pelletizing, pellets of each PHA sample were tested to determine the final weight average molecular weight of the PHA and the final melt flow index of the PHA. Molecular weight was determined by gel permeation chromatography according to ASTM D5296. Melt flow index was determined according to ASTM D1238, at 175° C. with a 10 kg load. The results are reported in Table 1 below:

TABLE 1

| | Initial Moisture | Final MFR | Final Mw | Mw % |
|---|---|---|---|---|
| Example | (Wt. %) | (g/10 min) | (g/mol) | Decrease |
| 1 | 0.15 | 4.7 | 848,946 | 17.74 |
| 2 | 0.19 | 4.6 | 802,536 | 22.23 |
| 3 | 0.23 | 4.51 | 879,750 | 14.75 |
| 4 | 0.23 | 6.11 | 811,246 | 21.39 |
| 5 | 0.4 | 4.56 | 827,916 | 19.78 |
| 6 | 0.41 | 5.3 | 862,950 | 16.38 |
| 7 | 0.65 | 4.77 | 890,776 | 13.68 |
| 8 | 0.68 | 5.1 | 837,293 | 18.87 |
| 9 | 0.89 | 5.61 | 848,470 | 17.78 |
| 10 | 0.93 | 5.08 | 839,212 | 18.68 |
| 11 | 0.97 | 5.05 | 865,231 | 16.16 |
| 12 | 1.24 | 4.87 | 906,173 | 12.19 |
| 13 | 1.6 | 4.38 | 961,481 | 6.83 |
| 14 | 2.47 | 4.6 | 877,781 | 14.94 |
| 15 | 2.53 | 4.88 | 793,130 | 23.15 |
| 16 | 3.1 | 4.4 | 875,546 | 15.16 |
| 17 | 3.27 | 4.9 | 864,512 | 16.23 |
| 18 | 3.72 | 5.4 | 824,430 | 20.11 |
| 19 | 5.76 | 4.33 | 847,274 | 17.90 |
| 20 | 6.23 | 4.46 | 863,577 | 16.32 |
| 21 | 6.64 | 4.63 | 797,797 | 22.69 |
| 22 | 8.37 | 4.6 | 815,008 | 21.03 |
| 23 | 8.56 | 4.65 | 824,207 | 20.13 |
| 24 | 9.11 | 4.8 | 832,601 | 19.32 |
| 25 | 9.11 | 5.9 | 863,808 | 16.30 |
| 26 | 9.38 | 4.76 | 902,910 | 12.51 |
| 27 | 10.02 | 4.52 | 865,384 | 16.14 |
| 28 | 10.27 | 4.72 | 901,443 | 12.65 |
| 29 | 10.29 | 7.1 | 917,349 | 11.11 |
| 30 | 12.12 | 6.37 | 887,559 | 14.00 |
| 31 | 14.08 | 5.33 | 897,974 | 12.99 |
| 32 | 14.5 | 5.6 | 892,237 | 13.54 |
| 33 | 14.85 | 5.71 | 884,850 | 14.26 |
| 34 | 15.04 | 5.11 | 904,070 | 12.40 |

From this, it may be seen that when the PHA was first processed in the continuous mixer in accordance with present disclosure and then subsequently extruded, the PHA retained at least 80% of its initial weight average molecular weight in nearly all cases. In many instances, the PHA retained at least 85% of its initial weight average molecular weight. Also, the final melt flow index of the PHA was less than 6.0 in nearly all cases and in many cases, less than 5.0 g/10 min. Since the melt flow index generally increases with decreasing molecular weight, these values for the melt flow index also indicate that degradation of the PHA and reduction in weight average molecular weight was relatively small.

These results are highly surprising given the large amounts of initial moisture in the PHA samples prior to processing in the continuous mixer and subsequent extrusion.

As noted above, no additives were mixed with the PHA in the foregoing examples. However, those of skill will appreciate that the inclusion or absence of additives such as rheology modifiers, nucleating agents, organic fillers, inorganic fillers, polyesters, and impact modifiers would not affect the molecular weight of the PHA. Therefore, similar molecular weight values for the PHA after mixing and extruding would be expected either with or without further resin additives.

### Comparative Examples 35-38

For comparative purposes, a further series of PHA samples were also prepared. As with the previous samples, the PHA was a poly-3-hydroxybutyrate-co-3-hydroxyhexanoate copolymer, comprising about 6 mole percent 3-hydroxyhexanoate monomer repeat units. The initial weight average molecular weight of the PHA copolymer varied from about 600,000 to about 1,100.00 g/mol, as noted in the table below.

As with the previous samples, the PHA was initially provided as a substantially dry powder. For each sample, the powder was mixed in a bucket with a known amount of water and stirred with a paint stirrer to provide a PHA sample having a known initial moisture content.

Unlike the previous samples, these control samples were prepared using an Entek 27 mm twin screw lab-scale extruder for comparison purposes. In the extruder, the PHA was heated to a temperature of about 120-140° C. and then extruded through a two-hole die into a water bath set at 150° F. to 160° F. (65° C. to 71° C.). The extruded PHA was then cut into pellets.

As with the previous examples, after extrusion and pelletizing, pellets of each PHA sample were tested to determine the final weight average molecular weight of the PHA and the final melt flow index of the PHA. Molecular weight was determined by gel permeation chromatography according to ASTM D5296. Melt flow index was determined according to ASTM D1238 at 175° C. with a 10 kg load. The results are reported in Table 2 below.

TABLE 2

| | Initial | | | | Melt Flow |
|---|---|---|---|---|---|
| | Moisture | Initial Mw | Final Mw | Mw % | Rate (g/10 |
| Example | (Wt. %) | (g/mol) | (g/mol) | decrease | min) |
| 35 | 0.11% | 1,032,000 | 607,000 | 41.18 | 8.81 |
| 36 | 0.15% | 605,000 | 514,000 | 15.04 | 8.41 |
| 37 | 0.10% | 1,162,000 | 603,000 | 48.11 | 6.25 |
| 38 | 0.12% | 943,000 | 600,000 | 36.37 | 28.28 |
| 39 | 0.12% | 847,000 | 529,000 | 37.55 | 12.61 |

These results contrast sharply with the results described above using the continuous mixer. In four of the five comparative examples, a molecular weight loss of over 35% was observed when starting with a PHA having an initial moisture content of only 0.10 to 0.15 weight %. Again, for the preceding examples, according to the present disclosure, the observed loss of weight average molecular weight was substantially lower, even when the initial moisture for the PHA was over an order of magnitude greater than in the comparative examples.

Moreover, the observed melt flow index for the comparative examples was also substantially higher than for the preceding examples, which used the continuous mixer. The present disclosure is also further illustrated by the following embodiments:

Embodiment 1. A r extruding a resin which includes polyhydroxyalkanoates, the method comprising the steps of:
mixing at least one polyhydroxyalkanoate in powder form with at least one resin additive at a temperature from about 120 to about 190° C. to form an extrusion mixture; and
extruding the mixture through an extrusion die to form a resin extrudate comprising the at least one polyhydroxyalkanoate and the at least one resin additive,
wherein the least one polyhydroxyalkanoate in powder form has an initial moisture content of at least 0.10 weight percent, as determined in accordance with ASTM D7191-05, when mixed with the at least one resin additive.

Embodiment 2. The method of Embodiment 1, wherein the least one polyhydroxyalkanoate in powder form has an initial moisture content of at least 1 weight percent, as determined in accordance with ASTM D7191-05 when mixed with the at least one resin additive.

Embodiment 3. The method of Embodiment 1 or 2, wherein the least one polyhydroxyalkanoate in powder form has an initial moisture content of at least 5 weight percent, more preferably at least 10 weight percent, and even more preferably at least 15 weight percent as determined in accordance with ASTM D7191-05 when mixed with the at least one resin additive.

Embodiment 4. The method, according to any of the preceding Embodiments, wherein the mixing step and the extruding steps are carried out in different devices or different chambers of the same device.

Embodiment 5. The method, according to any of the preceding Embodiments, wherein the mixing step is carried out in a continuous mixer.

Embodiment 6. The method, according to any of the preceding Embodiments, wherein the extruding step is carried out in a screw extruder.

Embodiment 7. The method, according to any of the preceding Embodiments, wherein the least one polyhydroxyalkanoate has an initial weight average molecular weight before the mixing step and a final weight average molecular weight after the extruding step, which is at least 40 percent, at least 70 percent, at least 80 percent, or at least 85 percent of the initial weight average molecular weight, wherein all weight average molecular weights are determined in accordance with ASTM D5296-05.

Embodiment 8. The method, according to any of the preceding Embodiments, wherein the at least one poly(hydroxyalkanoate) comprises poly-3-hydroxybutyrate-co-3-hydroxyhexanoate (“P(3HB-co-3HHx)”).

Embodiment 9. The method of Embodiment 8, wherein the P(3HB-co-3HHx) comprises from about 75 to about 99 mole percent hydroxybutyrate and from about 1 to about 25 mole percent hydroxyhexanoate.

Embodiment 10. The method, according to any of the preceding Embodiments, wherein the at least one poly(hydroxyalkanoate) comprises from about 1 to about 25 weight percent of at least one polyhydroxyalkanoate comprising from about 25 to about 50 mole percent of hydroxyvalerate, hydroxyhexanoate, hydroxyoctanoate, and/or hydroxydecanoate.

Embodiment 11. The method, according to any of the preceding Embodiments, wherein the at least one poly(hydroxyalkanoate) comprises a terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydroxyalkanoate having from 5 to 12 carbon atoms.

Embodiment 12. The method, according to any of the preceding Embodiments, wherein the at least one poly(hydroxyalkanoate) has an initial weight average molecular weight from about 50,000 Daltons to about 2.5 million Daltons, as determined by ASTM D5296-05.

Embodiment 13. The method, according to any of the preceding Embodiments, wherein the at least one resin additive comprises at least one rheology modifier selected from the group consisting of vinyl acetate homopolymers or copolymers, peroxides, epoxides, isocyanates, carbodiimides, and mixtures thereof.

Embodiment 14. The method, according to any of the preceding Embodiments, wherein the at least one resin additive comprises at least one nucleating agent from the group consisting of pentaerythritol, boron nitride, poly(hydroxybutyrate), inositol, clays, dipentaerythritol, sorbitol, and mixtures thereof.

Embodiment 15. The method, according to any of the preceding Embodiments, wherein the at least one resin additive comprises at least one filler selected from the group consisting of aragonite, clays, calcium carbonate, cellulose, nano-cellulose, talc, kaolinite, montmorillonite, bentonite, silica, chitin, starches, diatomaceous earth, titanium dioxide, nano clay, mica, and mixtures thereof.

Embodiment 16. The method, according to any of the preceding Embodiments, wherein the mixing step further comprises mixing the at least one polyhydroxyalkanoate in powder form with at least one biopolymer selected from the group consisting of biodegradable polymer selected from the group consisting of polybutylene succinate, polycaprolactone, polybutylene succinate-co-butylene adipate, polybutylene adipate-co-terephthalate, polylactic acid, cellulose acetate, and mixtures thereof.

The foregoing description of preferred embodiments for this invention has been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for extruding a resin which includes polyhydroxyalkanoates, the method comprising the steps of:
mixing at least one polyhydroxyalkanoate in powder form with at least one resin additive at a temperature from 120 to 190° C. to form an extrusion mixture; and
extruding the mixture through an extrusion die to form a resin extrudate comprising the at least one polyhydroxyalkanoate and the at least one resin additive,
wherein the least one polyhydroxyalkanoate in powder form has an initial moisture content of at least 0.1 weight percent, as determined in accordance with ASTM D7191-05, when mixed with the at least one resin additive.

2. The method of claim 1, wherein the least one polyhydroxyalkanoate in powder form has an initial moisture content of at least 1 weight percent, as determined in accordance with ASTM D7191-05 when mixed with the at least one resin additive.

3. The method of claim 1, wherein the least one polyhydroxyalkanoate in powder form has an initial moisture content of at least 5 weight percent, as determined in accordance with ASTM D7191-05 when mixed with the at least one resin additive.

4. The method of claim 1, wherein the mixing step and the extruding steps are carried out in different devices or in different chambers of the same device.

5. The method of claim 1, wherein the mixing step is carried out in a continuous mixer.

6. The method of claim 1, wherein the extruding step is carried out in a screw extruder.

7. The method of claim 1, wherein the least one polyhydroxyalkanoate has an initial weight average molecular weight before the mixing step and a final weight average molecular weight after the extruding step, which is at least 40 percent of the initial weight average molecular weight, wherein all weight average molecular weights are determined in accordance with ASTM D5296-05.

8. The method of claim 1, wherein the at least one poly(hydroxyalkanoate) comprises poly-3-hydroxybutyrate-co-3-hydroxyhexanoate (“P(3HB-co-3HHx)”).

9. The method of claim 8, wherein the P(3HB-co-3HHx) comprises from 75 to 99 mole percent hydroxybutyrate and from 1 to 25 mole percent hydroxyhexanoate.

10. The method of claim 1, wherein the at least one poly(hydroxyalkanoate) comprises from 1 to 25 weight percent of at least one polyhydroxyalkanoate comprising from 25 to 50 mole percent of hydroxyvalerate, hydroxyhexanoate, hydroxyoctanoate, and/or hydroxydecanoate.

11. The method of claim 1, wherein the at least one poly(hydroxyalkanoate) comprises a terpolymer made up from 75 to 99.9 mole percent monomer residues of 3-hydroxybutyrate, from 0.1 to 25 mole percent monomer residues of 3-hydroxyhexanoate, and from 0.1 to 25 mole percent monomer residues of a third 3-hydroxyalkanoate having from 5 to 12 carbon atoms.

12. The method of claim 1, wherein the at least one poly(hydroxyalkanoate) has an initial weight average molecular weight from 50,000 Daltons to 2.5 million Daltons, as determined by ASTM D5296-05.

13. The method of claim 1, wherein the at least one resin additive comprises at least one rheology modifier selected from the group consisting of vinyl acetate homopolymers or copolymers, peroxides, epoxides, isocyanates, carbodiimides, and mixtures thereof.

14. The method of claim 1, wherein the at least one resin additive comprises at least one nucleating agent selected from the group consisting of pentaerythritol, boron nitride, poly(hydroxybutyrate), inositol, clays, dipentaerythritol, sorbitol, and mixtures thereof.

15. The method of claim 1, wherein the at least one resin additive comprises at least one filler selected from the group consisting of aragonite, clays, calcium carbonate, cellulose, nano-cellulose, talc, kaolinite, montmorillonite, bentonite, silica, chitin, starches, diatomaceous earth, titanium dioxide, nano clay, mica, and mixtures thereof.

16. The method of claim 1, wherein the mixing step further comprises mixing the at least one polyhydroxyalkanoate in powder form with at least one biopolymer selected from the group consisting of biodegradable polymer selected from the group consisting of polybutylene succinate, polycaprolactone, polybutylene succinate-co-butylene adipate, polybutylene adipate-co-terephthalate, polylactic acid, cellulose acetate, and mixtures thereof.
